(19) United States
(12) Patent Application Publication
(10) Pub. No.: US 2009/0043618 A1
(43) Pub. Date: Feb. 12, 2009

(54) Work Management System, Work Management System Construction Support Service, Control Method and Program

(75) Inventors: Hisatoshi Adachi, Tokyo (JP); Makoto Kano, Yokohama-shi (JP); Yuhji Kikuma, Kawasaki-shi (JP)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, ARMONK, NY (US)

(21) Appl. No.: 11/817,041

(22) Filed: Aug. 24, 2007

(30) Foreign Application Priority Data
Feb. 25, 2005 (JP) 2005-51459
Feb. 25, 2006 (JP) PCT/JP2006/303449

(51) Int. Cl. G06Q 10/00

(52) U.S. Cl. 705/7

(57) ABSTRACT

[Object] Even when multiple work processes depending on one another progress in parallel, it is possible to appropriately manage the progress of the whole work that includes these work processes.

[Solution] A work management system for managing the progress of work is provided with a process recording section which records, in association with at least one of multiple work processes, previous processes which are other work processes providing a product for the work process; and a reference maturity degree recording section which records, for each of the previous processes associated with one work process recorded in the process recording section, a reference maturity degree which is the maturity degree of the product of the previous process required to start the one work process. For each of the previous processes recorded in the process recording section in association with one work process, the maturity degree of the product of the previous process is acquired. On condition that, for every previous process recorded in the process recording section in association with one work process, the maturity degree for the previous process is equal to or above the reference maturity degree for the previous process, it is notified that one work process can be started.

### TECHNICAL FIELD

The present invention relates to a work management system, a work management system construction support service, a control method and a program. Particularly, the present invention relates to a work management system for managing the progress of work, a work management system construction support service, a control method and a program.

### BACKGROUND ART

Recently, it has been an important issue for companies to perform work processes from procurement to sales promptly at a low cost. Especially, in manufacturing industry or computer system engineering industry, since a business process flow is common in which the product of a previous process is used for a following process, process management and progress management are very important for optimization of work. Therefore, a method referred to as a workflow system or a business process integration has been conventionally used as a method for supporting process management and progress management.

However, with the spread of work process optimization, the competition among companies is becoming more and more intense, and it is required to further shorten a work process. For example, there may be a case where a following process which is originally to be started after a previous process ends is started when the previous process has progressed to some extent. Thereby, it is possible, in some cases, to perform works in parallel which cannot be performed in parallel from the view point of form and shorten the whole processes.

For example, FIG. 1 shows a specific example of work that includes multiple work processes. This work is intended to develop a new automobile. FIG. 1(a) shows the workflow in the case of starting each work process after the previous process is completed. In this case, forty to forty-eight months are required from start to completion of the work. FIG. 1 (b) shows the workflow in the case of causing a part of work processes to progress in parallel to their previous process. In this case, twenty to twenty-two months are required from start to completion of the work, and the time for processing the work is shortened in comparison with FIG. 1 (a).

As a technique for supporting management of such work, there has been conventionally proposed a method in which a condition for starting a following process is stored in advance, and the progress state inputted by a user and the condition are compared to determine whether the following process can be started (see Patent Document 1 or 2). Thereby, even when a work process regarded as a previous process from the viewpoint of form exists, it is possible to appropriately determine whether the following process can be started or not and support improvement of the efficiency of the whole work.

### Patent Document 1: Japanese Patent Laid-Open No. 2003-345591

### Patent Document 2: Japanese Patent Laid-Open No. 2001-101310

### DISCLOSURE OF THE INVENTION

### Problems to be Solved by the Invention

In the technique of Patent Document 1, it is necessary to describe the condition for starting a work process in SQL capable of description for a general purpose (see FIG. 9 or 10). However, though application to various works is possible if description for a general purpose is possible, it depends on the experience or techniques of a creator of a condition whether the efficiency of a work process can be effectively improved or not. Furthermore, depending on the contents of the condition, a deadlock state may occur in which, among multiple work processes, a start condition for each of them is completion of another work process. It is difficult to appropriately detect such a deadlock state when a general-purpose condition can be described.

In the technique of Patent Document 2 also, it is not possible to support setting of a condition for improving the efficiency of the entire work, similarly to the technique of Patent Document 1. Furthermore, in this document, a method for preparing a condition for starting a work process is not described. If the manager of the whole work accurately grasps all the work processes, a trouble will not occur. However, in recent highly-advanced and complicated works, it is not practical to prepare start conditions for all work processes in advance.

Accordingly, the object of the present invention is to provide a work management system capable of appropriately managing the progress of work, a control method, a program, and a system construction support service therefor. This object is achieved by combination of the characteristics described in the independent claims in CLAIMS. The dependent claims specify further advantageous, specific examples of the present invention.

### SUMMARY OF THE INVENTION

In order to solve the above problems, the present invention provides a work management system for managing the progress of work, which is provided with: a process recording section which records, in association with at least one of multiple work processes included in the work, previous processes which are other work processes providing a product for the work process; a reference maturity degree recording section which records, for each of the previous processes associated with one work process recorded in the process recording section, a reference maturity degree which is the maturity degree of the product of the previous process required to start the one work process; a maturity degree acquisition section which acquires, for each of the previous processes recorded in the process recording section in association with the one work process, the maturity degree of the product of the previous process; and a notification section which notifies that the one work process can be started on condition that, for every previous process recorded in the process recording section in association with the one work process, the maturity degree for the previous process is equal to or above the reference maturity degree for the previous process; a control method for the work management system; and a program for causing an information processing apparatus to function as the work management system. The above summary of the invention does not enumerate all necessary characteristics of the present invention, and sub-combination of these characteristic groups can be the invention.

### ADVANTAGES OF THE INVENTION

According to the present invention, even when multiple work processes dependent on one another progress in parallel, it is possible to appropriately manage the progress of the whole work that includes such work processes.

### BEST MODE FOR CARRYING OUT THE INVENTION

The present invention will be described below through an embodiment of the invention. The embodiment described below, however, does not limit the invention to CLAIMS, and all the combinations of characteristics described in the embodiment are not necessarily required for solution means of the invention.

FIG. 2 shows products of previous processes which are required to start each work process. The work targeted by progress management by a work management system 40 according to this embodiment includes work processes 200, 210, 220, 230 and 240 as work processes. The work process 200 is a designing process of a pillar part A which is the part of a pillar portion of an automobile. The work process 210 is a designing process of a pillar part B which is the part of another pillar portion of the automobile. The work process 220 is a designing process of a hinge which enables opening/closing of the door of the automobile. The work process 230 is a designing process of the whole door of the automobile. The work process 240 is a designing process of seating equipment of the automobile.

Each of the work processes 200, 210 and 220 provides a product for the work process 230, and therefore it is a previous process of the work process 230. Specifically, the work process 200 provides the structural drawing of the pillar part A for the work process 230 as a product 205. The work process 210 provides the structural drawing of the pillar part B for the work process 230 as a product 215. The work process 220 provides the structural drawing of the door hinge for the work process 230 as a product 225. The work process 230 provides a product for the work process 240, and therefore it is a previous process of the work process 240. Specifically, the work process 230 provides a structural drawing of the door and the door hinge arrangement drawing for the work process 240 as products 232 and 235.

The work management system 40 according to this embodiment is intended to appropriately manage the progress of a whole work even when the work to be managed includes multiple work processes dependent on one another as described above and these work process progress in parallel. It is also intended to appropriately notify both of the person in charge of each work process and the manager of the whole work of information that is important to improve the efficiency of the work.

FIG. 3 shows the entire configuration of a manufacturing site network 30 according to this embodiment. The manufacturing site network 30 includes the work management system 40, manager terminals and 310, person-in-charge terminals 320, 330, 340, 350 and 360. The manager terminal 300 displays information to a manager who manages the progress of work or inputs an instruction from the manager. The manager terminal 310 displays information to a manager who assigns work processes to persons in charge or inputs an instruction from the manager.

The person-in-charge terminal 320 notifies information to a person in charge of a work process for designing the pillar part A of the side panel of the automobile or inputs an instruction from the person in charge. The person-in-charge terminal 330 notifies information to a person in charge of a work process for designing the door hinge of the automobile or inputs an instruction from the person in charge. The person-in-charge terminal 340 notifies information to a person in charge of a work process for designing the door of the automobile or inputs an instruction from the person in charge. The person-in-charge terminal 350 notifies information to a person in charge of a work process for designing the pillar part B of the side panel of the automobile or inputs an instruction from the person in charge. The person-in-charge terminal 360 notifies information to a person in charge of a work process for designing the seating equipment of the automobile or inputs an instruction from the person in charge.

FIG. 4 shows the configuration of the work management system 40. The work management system 40 is a system for managing the process of work and used by a person in charge of a work process or a manager of the whole work. The work management system 40 has a processing section for person in charge 50, a processing section for manager 60, a process recording section 400, a reference maturity degree recording section 410, a maturity degree recording section 420 and a history recording section 430. The processing section for person in charge 50 records information inputted from the person-in-charge terminals 320, 330, 340 and 350 in the process recording section 400, the reference maturity degree recording section 410, the maturity degree recording section 420 and the history recording section 430. The processing section for person in charge 50 displays information on the person-in-charge terminals 320, 330, 340, 350 and 360 to notify the information to the persons in charge of the work processes. The processing section for manager 60 changes the information recorded in the process recording section 400, the reference maturity degree recording section 410, the maturity degree recording section 420 and the history recording section 430 on the basis of an instruction inputted from the manager terminals 300 and 310. The processing section for manager 60 causes the manager terminals 300 and 310 to display information to notify the information to the manager.

FIG. 5 shows an example of the data structure of the process recording section 400. The process recording section 400 records, in association with at least one of multiple work processes included in work to be managed, the identification information (ID) about the work process, the name of the work process and the identification information (IDs) about the previous processes, which are other work processes for providing a product for the work process. Specifically, the process recording section 400 records, in association with the work process for designing the door, the ID of each of the work process for designing the pillar part A, the work process for designing the pillar part B and the work process for designing the door hinge. Furthermore, the process recording section 400 may record information indicating various attributes of the work process, for example, the deadline to complete the work process.

FIG. 6 shows an example of the data structure of the reference maturity degree recording section 410. The reference maturity degree recording section 410 records, for each of the previous processes corresponding to one work process recorded in the process recording section 400, the reference maturity degree, which is the maturity degree of the product of the previous process required to start the one work process. More specifically, the reference maturity degree recording section 410 records initially set reference maturity degrees, which are reference maturity degrees specified in advance on the basis of an instruction by the manager or the like.

In response to reference maturity degrees having been inputted by a reference maturity degree input section 505 to be described later on the basis of an instruction by the person in charge of the work process, the reference maturity degree recording section 410 records the inputted reference maturity degrees as additional reference maturity degrees.

Since the data structure of the initially set reference maturity degrees and that of the additional reference maturity degrees are the same, a specific example will be described using the initially set reference maturity degrees as an example. For each maturity degree, the reference maturity degree recording section 410 records the reference maturity degree of the product of each previous process required to start a work process for generating a product with the maturity degree. For example, the table for Level 3 displayed at the front of the diagram shows the reference maturity degrees to be a condition for starting work for raising the level of the maturity degree of the product of each work process from Level 2 to Level 3. As an example, in order to start the work for raising the maturity degree of the product of the work process for designing the door (ID2) from Level 2 to Level 3, it is necessary that the maturity degree for the work process for designing the pillar part A is equal to or above Level 4, the maturity degree for the work process for designing the pillar part B is equal to or above Level 3, and the maturity degree for the work process for designing the door hinge is equal to or above Level 4.

FIG. 7 shows an example of the data structure of the maturity degree recording section 420. The maturity degree recording section 420 records, in association with each work process, a maturity degree acquired by a maturity degree acquisition section 508 to be described later. Furthermore, the maturity degree recording section 420 records, in association with each work process, information indicating whether or not to permit start of the work in a state that, at any of the previous processes of the work process, the maturity degree of the product is below the reference maturity degree (herein after referred to as preceding start). Furthermore, the maturity degree recording section 420 records information indicating whether or not each work process has actually made a preceding start.

FIG. 8 shows an example of the data structure of the history recording section 430. The history recording section 430 records, in association with each work process, the number of processes required to raise the maturity degree of the product as the history of the work process. For example, the history recording section 430 records that the number of processes corresponding to six man-days was required to raise the maturity degree of the product of the work process for designing the door (ID2) from Level 1 to Level 2. Furthermore, the history recording section 430 records, for each work process, the maturity degree of the products of the previous processes used for raising the maturity degree of the product of the work process.

FIG. 9 shows the functions of the processing section for person in charge 50 classified in function blocks. The processing section for person in charge 50 has an input section 500, a notification section 510, a deadlock detection section 520, a process detection section 530, a maturity detection section 540, a weight recording section 550, a maturity degree calculation section 560 and a maturity degree definition recording section 570. The input section 500 inputs information from the person-in-charge terminals 320, 330, 340 and 350. Specifically, the input section 500 has a process input section 502, a reference maturity degree input section 505 and a maturity degree acquisition section 508. For a work process specified by a person in charge, the process input section 502 inputs the previous processes which provide a product for the work process to cause them to be recorded in the process recording section 400. The reference maturity degree input section 505 inputs, in association with the work process specified by the person in charge, the reference maturity degree of each of the previous processes of the work process, on the basis of specification by the person in charge. For example, in response to the maturity degree acquisition section 508 having acquired, for the same work process, a maturity degree higher than a maturity degree already acquired, the reference maturity degree input section 505 may request the user to specify the reference maturity degrees of the previous processes of the work process required to further raise the maturity degree of the product of the work process.

The maturity degree acquisition section 508 inputs the maturity degree of the product of each work process and records it in the maturity degree recording section 420. For example, each time the maturity degree of the product of a certain work process rises, the maturity degree acquisition section 508 may input the maturity degree specified by the person in charge and record it in the maturity degree recording section 420 in association with the number of processes required to raise the maturity degree. The maturity degree definition recording section 570 may record, in association with at least one of the multiple work processes included in the work, definition of the maturity degree of the product of the work process. In this case, the maturity degree acquisition section 508 may acquire the maturity degree of the product by outputting the definition recorded in the maturity degree definition recording section 570 to the user and causing the user to specify the maturity degree of the product of the work process.

On condition that, for every previous process recorded in the process recording section 400 in association with a certain work process, the maturity degree for the previous process is equal to or above the reference maturity degree for previous process, the notification section 510 notifies the person in charge that the work process can be started. In the case where multiple reference maturity degrees are recorded in the reference maturity degree recording section 410 for the same work process, the notification section 510 compares the reference maturity degree inputted by the reference maturity degree input section 505, that is, the additional reference maturity degree with the maturity degree to make notification. Thereby, it is possible to preferentially use the reference maturity degree which is appropriately modified by the person in charge during progress of the work, and therefore it is possible to reflect not only the plan of the work but also the actual situation to make appropriate determination. The notification section 510 may notify the person in charge of each work process of various information such as information whether the preceding start of the work process is permitted or not.

In response to a previous process having been newly inputted by the process input section 502 and the reference maturity degree of the previous process being inputted by the reference maturity degree input section 505, the deadlock detection section 520 detects deadlock concerning the previous process. Specifically, the deadlock detection section 520 detects that, for multiple work processes including the newly inputted previous process, the multiple work processes are in such a relationship that they require a product with a higher maturity degree of another work process to generate a product with a higher maturity degree. On condition that deadlock has been detected, the notification section 510 notifies the person in charge that the newly inputted previous process or the reference maturity degree will be changed in association with information to the effect that the deadlock has been detected. Thereby, it is possible to prevent deadlock and prevent delay in the work.

The process detection section 530 detects a preceding-start process, which is a work process started in a state that, at any previous process, the maturity degree of the product is below the reference maturity degree. It is possible to determine whether each work process is a preceding-start process or not, for example, by referring to the information recorded in the maturity degree recording section 420. The process detection section 530 detects a preceding-start process from among work processes which are permitted preceding start by a setting section 630 to be described later. On condition that a preceding-start process has been detected, the maturity detection section 540 detects that the maturity degree of the product has risen to the reference maturity degree or above at any previous process of the preceding-start process. In response to the maturity degree of the product of the previous process of the preceding-start process having risen to the reference maturity degree or above, the notification section 510 notifies the person in charge of the preceding-start process that the product is usable at the preceding-start process. Thereby, it is possible to cause a product newly completed at a previous process to be used by the following process as soon as possible.

The weight recording section 550 records, in association with each of the previous processes of at least one work process, weight indicating the degree of contribution by the previous process to the product of the work process. If the maturity degree of the product of a certain work process is not recorded in the maturity degree recording section 420, that is, if the maturity degree has not been acquired by the maturity degree acquisition section 508, the maturity degree calculation section 560 calculates the maturity degree of the product of the work process with the use of the weight recorded in the weight recording section 550. For example, the maturity degree calculation section 560 calculates a value obtained by multiplying the maturity degree of the product of each of all the previous processes of the work process by the weight corresponding to the previous process and summing up all the multiplied maturity degrees, as the maturity degree of the product of the work process. Thereby, even when the maturity degree of the product of a previous process of a certain work process cannot be acquired, the notification section 510 can determine whether the maturity degree of the product of the previous process is equal to or above the reference maturity degree on the basis of the maturity degree of the previous process calculated by the maturity degree calculation section 560.

FIG. 10 shows the functions of the processing section for manager 60 classified in function blocks. The processing section for manager 60 has a state display section 600, a maturity degree changing section 610, an additional man-hour calculation section 620, a setting section 630 and a reference maturity degree update section 640. For each of the multiple work processes, the state display section 600 acquires the maturity degree of the product of the work process from the maturity degree recording section 420 and causes it to be displayed on the manager terminal 300 or the manager terminal 310. For each of the multiple work processes, the state display section 600 determines whether or not, at any previous process of the work process, the maturity degree of the product is below the reference maturity degree on the basis of the information in the process recording section 400, the reference maturity degree recording section 410 and the maturity degree recording section 420, and causes the determination result to be displayed on the manager terminal 300 or the manager terminal 310.

When receiving an instruction to lower the maturity degree of the product of any work process from the manager terminal 300, the maturity degree changing section 610 lowers the maturity degree of the product in the maturity degree recording section 420. As lowering the maturity degree of the product of the work process, the maturity degree changing section 610 further lowers the maturity degrees of the products of other work processes using the product with the maturity degree in the maturity degree recording section 420. Thereby, even when modification is required in work already completed after the work progresses to some extent, it is possible to appropriately continue management of the progress of the work. For a preceding-start process, which has been started in a state that, the maturity degree of the product of any previous process was below the reference maturity degree, among such work processes that a work process with a maturity degree to be lowered is the previous process thereof, the maturity degree changing section 610 does not lower the maturity degree. This is because, in the case of a preceding-start process, the product of a previous process may not be used, and the effect of lowering the maturity degree of the product of a previous process may not be expected.

Preferably, prior to the maturity degree changing section 610 lowering the maturity degrees, the additional man-hour calculation section 620 calculates additional man-hours, which is the total man-hours required as a result of the maturity degree changing section 610 lowering the maturity degrees in the case where the maturity degree of the product of a specified work process has been lowered. Then, the maturity degree changing section 610 outputs the additional man-hours calculated by the additional man-hour calculation section 620 to the user, and lowers the maturity degree of the product of the specified work process on condition that the user agrees in response to the output of the additional man-hours. Thereby, it is possible for the manager of the work to know the effect of lowering the maturity degree in advance before determining whether or not to lower the maturity degree.

The setting section 630 sets, in association with each work process, whether or not to permit start of the work in a state that, at any previous process of the work process, the maturity degree of a product is below the reference maturity degree. For example, in the case of receiving an instruction from the manager of the work through the manager terminal 300, the setting section 630 may set whether or not to permit preceding start of the work on the basis of the contents of the instruction. Thereby, in the case where the risk of extending the processing time of the work cannot be allowed, such as the case where the deadline of the work is near, it is possible to prohibit the preceding start to reduce the risk.

The reference maturity degree update section 640 selects a part specified by the manager of the work from among reference maturity degrees inputted by the reference maturity degree input section 505 (that is, additional reference maturity degrees) to update the initially set reference maturity degrees with the selected reference maturity degrees. Thereby, for example, in the case where the entire work is completed and development of the automobile is completed, the manager or the like can acquire a necessary part from among the reference maturity degrees changed during the development of the automobile and reflect it on the development of the next model.

FIG. 11 is a flowchart of the processing for the processing section for person in charge 50 to notify information to a person in charge. The processing section for person in charge 50 performs the following processing for each work process periodically or each time a maturity degree or a reference maturity degree is acquired. First, the process detection section 530 determines whether the work process is a preceding-start process or not (S1100). If it is a preceding-start process (S1110: YES), then the maturity detection section 540 determines whether or not, at any previous process of the preceding-start process, the maturity degree has risen to the reference maturity degree or above (S1110). If the maturity degree has risen to the reference maturity degree or above (S1110: YES), then the input section 500 notifies the person in charge of the preceding-start process that the product the maturity degree of which has risen to the reference maturity degree or above is usable at the preceding-start process (S1120).

On the other hand, if the work process is not a preceding-start process (S1100: NO), the notification section 510 determines whether or not, at all the previous processes of the work process, the maturity degree of the product has risen to the reference maturity degree or above (S1130). If the maturity degree of the product has risen to the reference maturity degree or above at all the previous processes (S1130: YES), then the input section 500 notifies the person in charge of the work process that the work process can be started (S1140).

FIG. 12 shows an example of screen display of the person-in-charge terminal 340 (a first example). For the maturity degree of the product of each work process, a level corresponding to the height of the degree is set. A definition indicating the height of the maturity degree is specified for each level, and the definition is recorded in the maturity degree definition recording section 570. The definition of the height of the maturity degree is displayed on the screen of the person-in-charge terminal 340 on the basis of a user instruction. For example, Level 0 indicates a state in which the work process has not been started yet, and Level 1 indicates a state in which the external shape of the final product has been completed, and the shape formed by setting reference lines, reference planes and main sections has been completed. Level 2 indicates a state in which the layout/model of the final product has been completed, and specifically indicates a state in which a shape with the installation positions of main parts to be installed and relief of main parts taken into account has been completed.

Level 3 indicates a state in which a shape with various detailed features such as bosses and ribs added thereto has been completed. Level 4 indicates a state in which a shape with shape modification such as apertures and rails and production technique requirements such as joggles and beads reflected there on has been completed. Level 5 indicates a state in which the final product has been completed. In this way, by specifying a definition of a standard level for each product on the basis of the characteristics of the product, it is possible for the person in charge of the work process to easily input the maturity degree of the product he is in charge of, and it is possible for the manager of the work to easily grasp the progress of the entire work.

FIG. 13 shows an example of screen display of the person-in-charge terminal 340 (a second example). Each of the person-in-charge terminals 320, 330, 340 and 350 notifies and displays the maturity degree of the product of the work process it is responsible for and the maturity degree of the product of each of the previous processes of the work process. In this diagram, an example of screen display of the person-in-charge terminal 340 among the person-in-charge terminals will be described. The person-in-charge terminal 340 displays the maturity degree of the product of the work process for designing the door of the automobile by a bar graph. For example, the person-in-charge terminal 340 arrays marks indicating the respective levels of the maturity degree at the upper part of the graph, and shows processes already completed (without diagonal lines) and processes currently being performed (with diagonal lines) so that they are distinguished from each other. The mark shown at the lower part of the graph indicates the maturity degree of the product which should be reached currently in view of the initial plan. The diamond shape mark shown at the upper part of the graph indicates the target value of the maturity degree to be achieved by a predetermined deadline.

Then, for each of the designing process of the pillar part A, the designing process of the pillar part B and the designing process of the door hinge, each of which is a previous process of the work process for designing the door, the person-in-charge terminal 340 shows the maturity degree of the product by a bar graph. The meaning indicated by the graph is the similar to the case of the maturity degree of the door. The arrow in the graph indicates the reference maturity degree. Thus, in the example of this diagram, the maturity degree is equal to or above the reference maturity degree at all the previous processes of the door designing process, and the door designing process has already been started. From this screen, the person in charge of each work process can grasp the progress state of the works of the previous processes in real time and appropriately adjust the schedule of the work process he is in charge of.

It is desirable that input by or notification to the person in charge of the work process is basically performed through this screen. For example, when the maturity degree has risen to the reference maturity degree or above at all the previous processes of the door designing process, the notification section 510 displays a pop-up message to that effect on this screen. The maturity degree acquisition section 508 may cause the user to call the screen shown in FIG. 12 on a menu screen which can be called from this screen and input the maturity degree of the product of his work process specified by him.

FIG. 14 shows an example of screen display of the person-in-charge terminal 340 (a third example). Similar to FIG. 13, the person-in-charge terminal 340 displays the maturity degree of the product of the work process for designing the door of the automobile by a bar graph. However, unlike FIG. 13, the maturity degree of the product is below the reference maturity degree at the designing process of the pillar part A, which is a previous process of this work process. Therefore, the person-in-charge terminal 340 displays a dotted bar graph to indicate that the work process of the door is a preceding-start process. In the display example of this diagram, when the maturity degree of the pillar part A rises to the reference maturity degree or above, the notification section 510 notifies it to the user with the use of a pop-up message or the like.

FIG. 15 is a flowchart of the processing for the processing section for person in charge 50 to input a maturity degree or a reference maturity degree. The process input section 502 inputs, for each work process, the previous processes of the work process specified by the user (S1500). For example, the system manager or the like of the work management system 40 may interview the person in charge of each work process to acquire information about the previous processes of the work process from him and cause the information to be inputted to the work management system 40. For each work process, the reference maturity degree input section 505 inputs reference maturity degrees, which are the maturity degrees of the previous processes required to start the work process (S1510). For example, the system manager or the like of the work management system 40 may interview the person in charge of each work process to acquire information about the reference maturity degrees of the previous processes of the work process from him and cause the information to be inputted to the work management system 40. In addition to or instead of this, the reference maturity degree input section 505 may request the person in charge to specify a reference maturity degree, at the timing of a parameter displayed on the person-in-charge terminal 340, such as the maturity degree, being updated. For example, in response to the maturity degree acquisition section 508 having acquired, for the same work process, a maturity degree different from a maturity degree already acquired, the reference maturity degree input section 505 may display a message requesting specification of a reference maturity degree on the person-in-charge terminal 340.

In response to the reference maturity degrees of the previous processes having been inputted, the deadlock detection section 520 determines deadlock among the multiple work processes including the previous processes (S1520). When deadlock is detected, the notification section 510 notifies it to the person in charge (S1530). Furthermore, the maturity degree acquisition section 508 acquires, for each of business process, the maturity degree of the product (S1540). For example, the system manager or the like of the work management system 40 may interview the person in charge of each work process to acquire information about the maturity degree of the product of the work process from him and cause the information to be inputted to the work management system 40. The maturity degree acquisition section 508 may operate in linkage with software for causing a work process to progress (for example, CAD software for creating a design drawing) and input maturity degrees on the basis of an instruction from the software. If the maturity degree for any business process has not been not inputted (S1550: YES), then the maturity degree calculation section 560 may calculate the maturity degree of the work process on the basis of the maturity degrees of the products of the respective previous processes of the work process (S1560).

FIG. 16 is a flowchart of the processing for the processing section for manager 60 to display information to the manager. For each of the multiple work processes, the state display section 600 displays the maturity degree of the product of the work process and the like on the manager terminal 300 or the manager terminal 310 (S1600). When receiving a work process specified as a candidate to be targeted by lowering of the maturity degree of the product as well as an instruction to calculate additional man-hours (S1610: YES), the additional man-hour calculation section 620 calculates the additional man-hours, which is the total man-hours required as a result of the maturity degree changing section 610 lowering the maturity degrees in the case where the maturity degree of the product of the specified work process has been lowered (S1620). Then, the maturity degree changing section 610 displays the additional man-hours calculated by the additional man-hour calculation section to the user.

Then, in the case of receiving an input to the effect that the user agrees the change of the maturity degree, in response to the display of the additional man-hours (S1630: YES), then the maturity degree changing section 610 changes the maturity degree of the specified work process (S1640). When the setting about whether or not to permit preceding start has been changed for any work process (S1650: YES), then the setting section 630 records the changed setting in the maturity degree recording section 420 (S1660).

FIG. 17 shows an example of screen display of the manager terminal (a first example). As shown in the example of this diagram, the state display section 600 displays the maturity degree of the product of each work process on the manager terminal 300, for example, as a three-dimensional bar graph. This bar graph may be displayed in association with each work process, on a three-dimensional drawing showing the arrangement in a company where the work process is actually progressing. Thereby, the manager of the work can instantaneously grasp the progress condition of each work process. The manager terminal 300 may display, for each work process, information indicating whether or not the work has been started in a state that, at any previous process of the work process, the maturity degree of the product is below the reference maturity degree, on the basis of an instruction of the state display section 600. For example, the manager terminal 300 may display the bar graph colored with a color indicating it. The manager terminal 300 may display a bar graph indicating a different meaning on the basis of a user instruction. For example, since target values are predetermined for the production cost of parts or the quality and quantity of the parts in development of an automobile, it is possible to more efficiently manage the entire work by displaying the values of difference between such target values and actual values as a bar graph.

FIG. 18 shows an example of screen display of the manager terminal 300 (a second example). The processing for the additional man-hour calculation section 620 to calculate and display the additional man-hours will be described with the use of this example. The manager inputs a product to be a candidate to be targeted by lowering of the maturity degree and the lowered maturity degree, with the use of the pull-down menu shown at the upper part of the diagram. The additional man-hour calculation section 620 displays a list of other work processes which use the product with the maturity degree. Specifically, the additional man-hour calculation section 620 displays, for each work process, the person in charge, the product, the current maturity degree of the product, the changed maturity degree of the product and the additional man-hours, which is the total of the man-hours required as a result of lowering the maturity degree, in association with one another. The additional man-hours can be calculated on the basis of the past man-hours recorded in the history recording section 430. Thereby, it is possible for the manager of the work to know the effect of lowering the maturity degree in advance before determining whether or not to lower the maturity degree.

FIG. 19 shows an example of the hardware configuration of an information processing apparatus 800 functioning as the work management system 40. The information processing apparatus 800 is provided with a CPU peripheral part having a CPU 1000, a RAM 1020 and a graphic controller 1075 which are mutually connected via a host controller 1082; an input/output part having a communication interface 1030, a hard disk drive 1040 and a CD-ROM drive 1060 which are connected to the host controller 1082 via an input/output controller 1084; and a legacy input/output part having a ROM 1010, a flexible disk drive 1050 and an input/output chip 1070 which are connected to the input/output controller 1084.

The host controller 1082 connects the RAM 1020 to the CPU 1000 and the graphic controller 1075 which access the RAM 1020 at a high transfer rate. The CPU 1000 operates on the basis of programs stored in the ROM 1010 and the RAM 1020 to control each part. The graphic controller acquires image data generated by the CPU 1000 or the like on a frame buffer provided in the RAM 1020, and displays it on a display device 1080. Instead, the graphic controller 1075 may include the frame buffer for storing the image data generated by the CPU 1000 or the like, inside it.

The input/output controller 1084 connects the host controller 1082 to the communication interface 1030, the hard disk drive 1040 and the CD-ROM drive 1060 which are relatively high speed input/output devices. The communication interface 1030 communicates with an external device via a network. The hard disk drive 1040 stores programs and data to be used by the information processing apparatus 800. The CD-ROM drive 1060 reads a program or data from a CD-ROM 1095 and provides it for the RAM 1020 or the hard disk drive 1040.

The ROM 1010 and relatively low speed input/output devices, such as the flexible disk drive 1050 and the input/output chip 1070, are connected to the input/output controller 1084. The ROM 1010 stores a boot program, which is executed by the CPU 1000 when the information processing apparatus 800 is activated, and programs dependent on the hardware of the information processing apparatus 800. The flexible disk drive 1050 reads a program or data from a flexible disk 1090 and provides it for the RAM 1020 or the hard disk drive 1040 via the input/output chip 1070. The input/output chip 1070 connects the flexible disk 1090 or connects various input/output devices, for example, via a parallel port, a serial port, a keyboard port, a mouse port or the like.

The program to be provided for the information processing apparatus 800 is stored in a recording medium such as the flexible disk 1090, the CD-ROM 1095 and an IC card, and provided by a user. The program is read from the recording medium via the input/output chip 1070 and/or the input/output controller 1084, installed in the information processing apparatus 800 and executed. The operation which the program causes the information processing apparatus 800 to perform is the same as the operation in the work management system 40 described through FIGS. 1 to 18, and description thereof will be omitted.

The program described above may be stored in an external storage medium. As the storage medium, an optical recording medium such as a DVD and a PD, a magneto-optic recording medium such as an MD, a tape medium, and a semiconductor memory such as an IC card may be used, in addition to the flexible disk 1090 and the CD-ROM 1095. It is also possible to use a storage device such as a hard disk and a RAM provided for a server system connected to a dedicated communication network or the Internet as a recording medium to provide the program for the information processing apparatus 800 via the network.

As described above, according to the work management system 40 of this embodiment, it is possible to, even when multiple work processes depending on one another progress in parallel, appropriately manage the progress of the whole work that includes these work processes by using a unified criterion, that is, the maturity degree of a product. For example, on condition that, at all the previous processes of a work process, the maturity degree of the product has risen to a reference maturity degree or above, the work management system 40 can notify the person in charge to the effect that the work process is to be started. Furthermore, if, at any previous process of a work process which has already started, the maturity degree of the product has risen to the reference maturity degree or above, it is notified so that smooth progress of the work can be supported.

The present invention has been described with the use of an embodiment. However, the technical scope of the present invention is not limited to the range described in the above embodiment. It is apparent to those skilled in the art that various modifications or improvements can be made to the embodiment described above. It is apparent from the description in CLAIMS that such modified or improved embodiments can be included in the technical scope of the present invention.

### BRIEF DESCRIPTION OF THE DRAWINGS

FIG. 1 shows specific examples of work that includes multiple work processes;

FIG. 2 shows products of previous processes required to start each work process;

FIG. 3 shows the entire configuration of a manufacturing site network 30 according to this embodiment;

FIG. 4 shows the configuration of a work management system 40;

FIG. 5 shows an example of the data structure of a process recording section 400;

FIG. 6 shows an example of the data structure of a reference maturity degree recording section 410;

FIG. 7 shows an example of the data structure of a maturity degree recording section 420;

FIG. 8 shows an example of the data structure of a history recording section 430;

FIG. 9 shows the functions of a processing section for person in charge 50 classified in function blocks;

FIG. 10 shows the functions of a processing section for manager 60 classified in function blocks;

FIG. 11 is a flowchart of the processing for the processing section for person in charge 50 to notify information to a person in charge;

FIG. 12 shows an example of screen display of a person-in-charge terminal 340 (a first example);

FIG. 13 shows an example of screen display of the person-in-charge terminal 340 (a second example);

FIG. 14 shows an example of screen display of the person-in-charge terminal 340 (a third example);

FIG. 15 is a flowchart of the processing for the processing section for person in charge 50 to input a maturity degree or a reference maturity degree;

FIG. 16 is a flowchart of the processing for the processing section for manager 60 to display information to the manager;

FIG. 17 shows an example of screen display of a manager terminal 300 (a first example);

FIG. 18 shows an example of screen display of the manager terminal 300 (a second example); and

FIG. 19 shows an example of the hardware configuration of an information processing apparatus 800 functioning as the work management system 40.

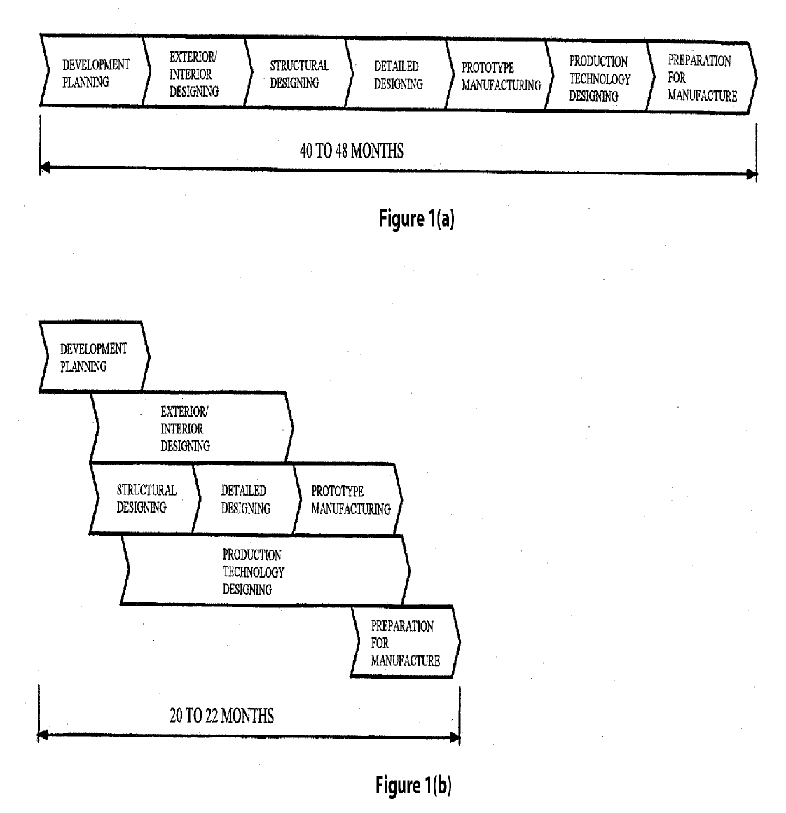

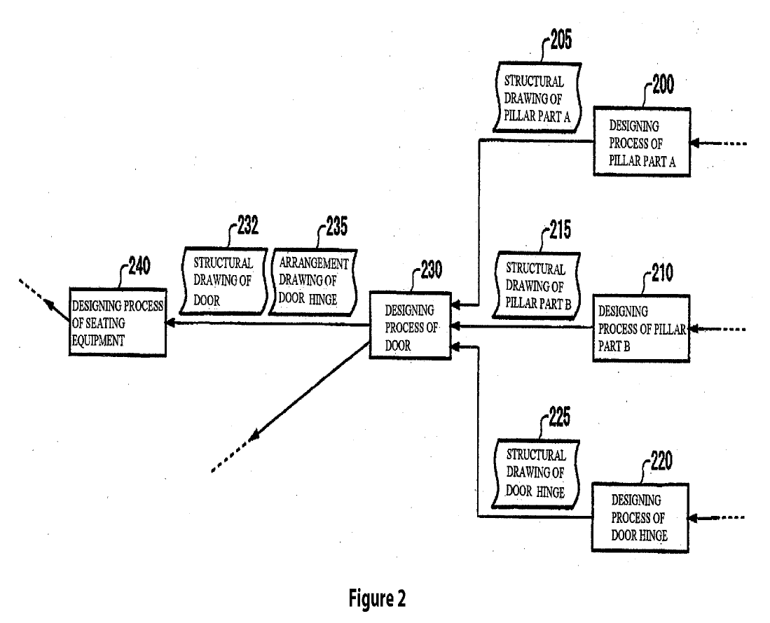

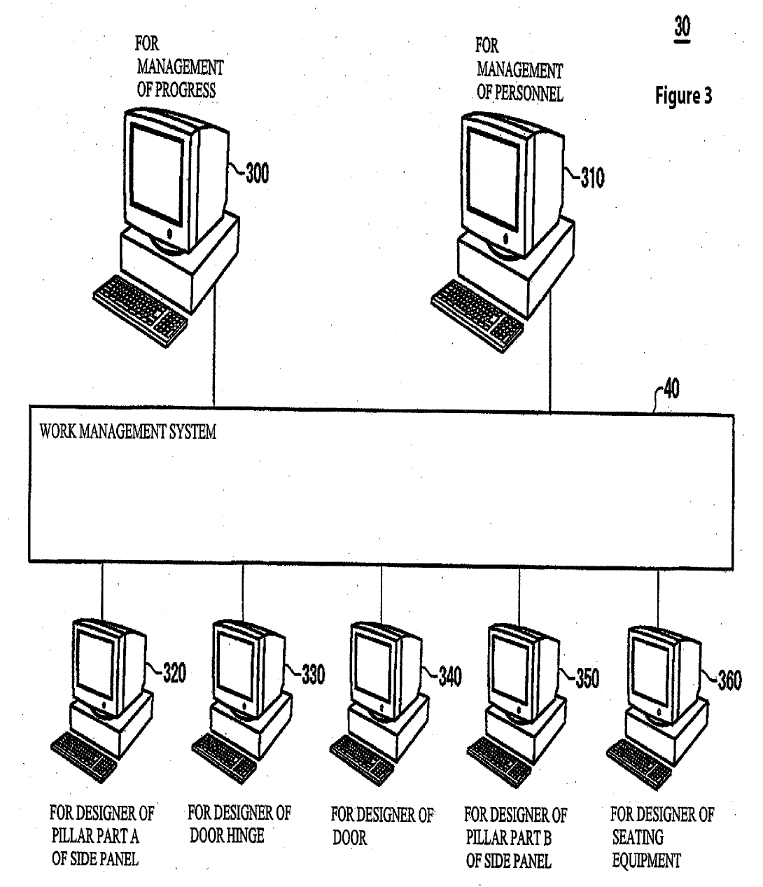

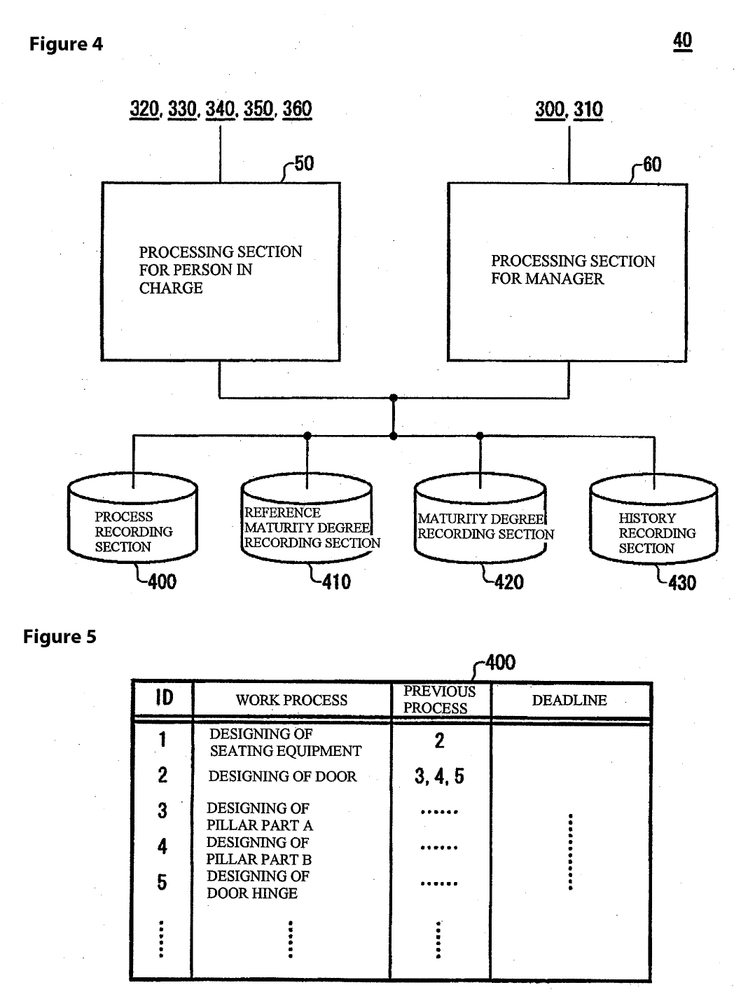

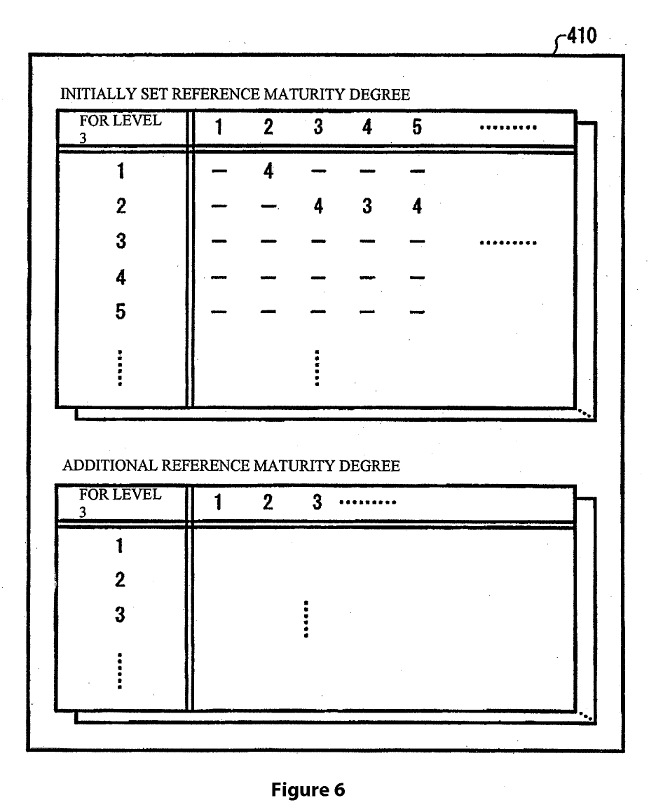

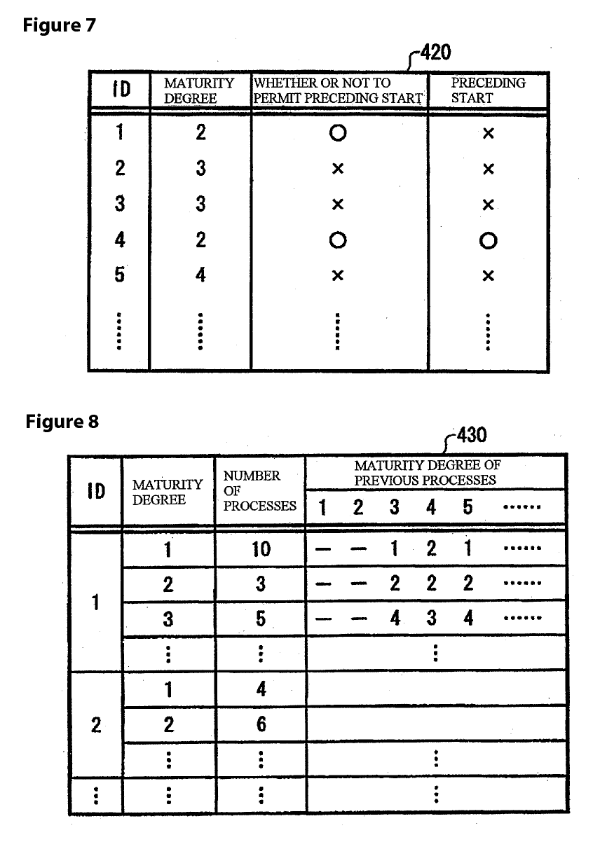

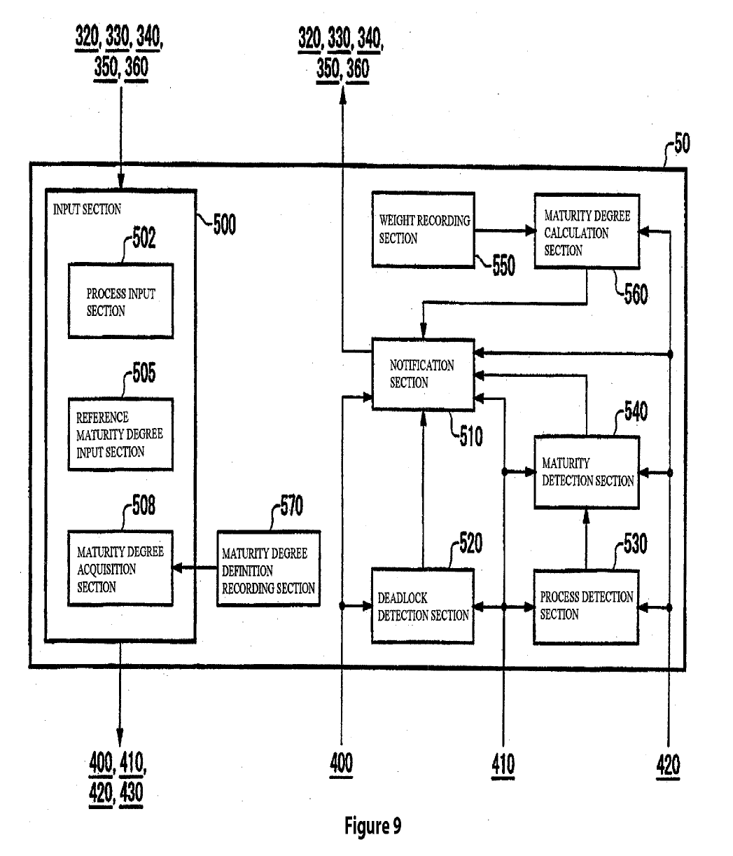

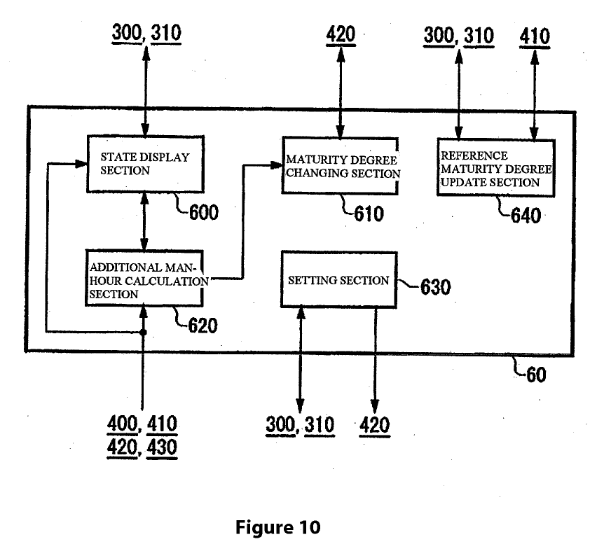

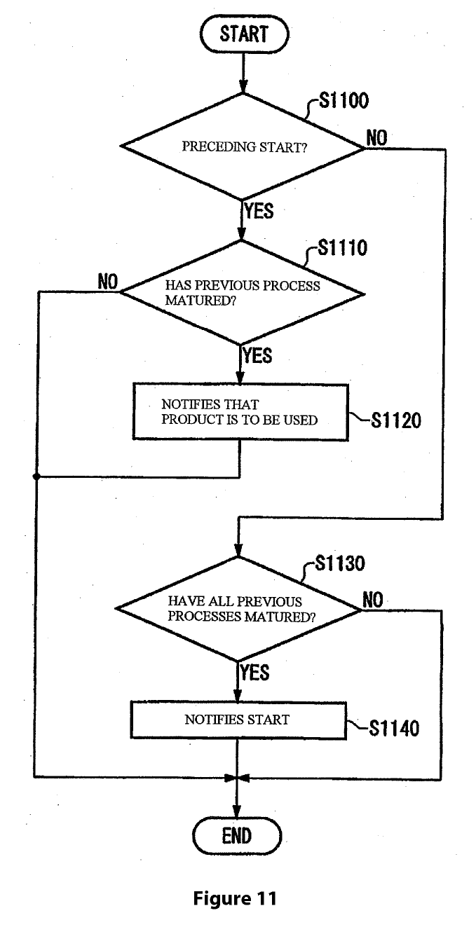

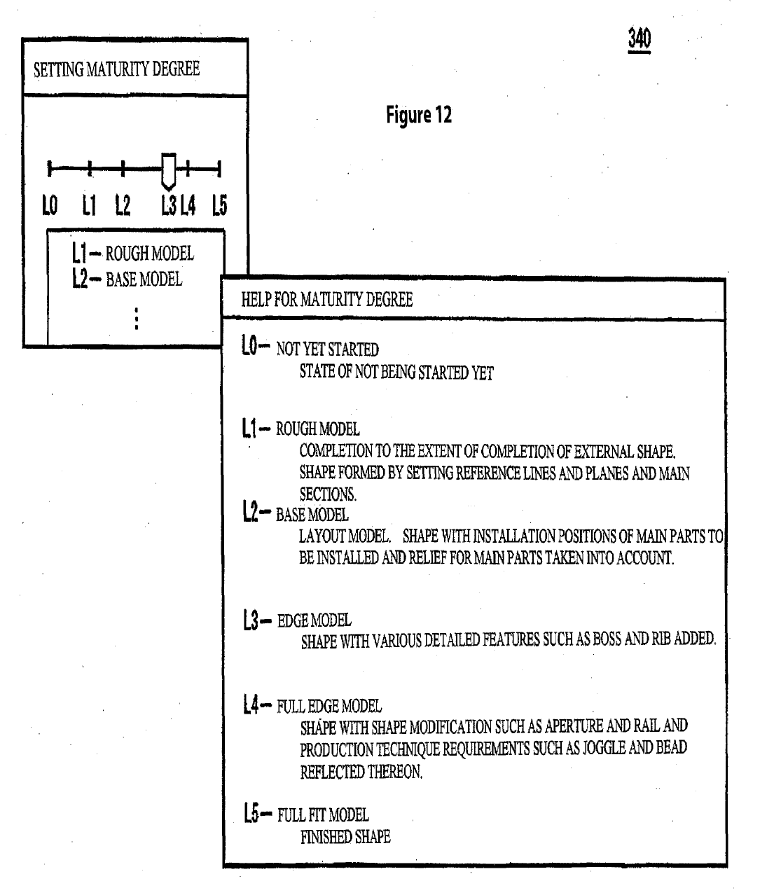

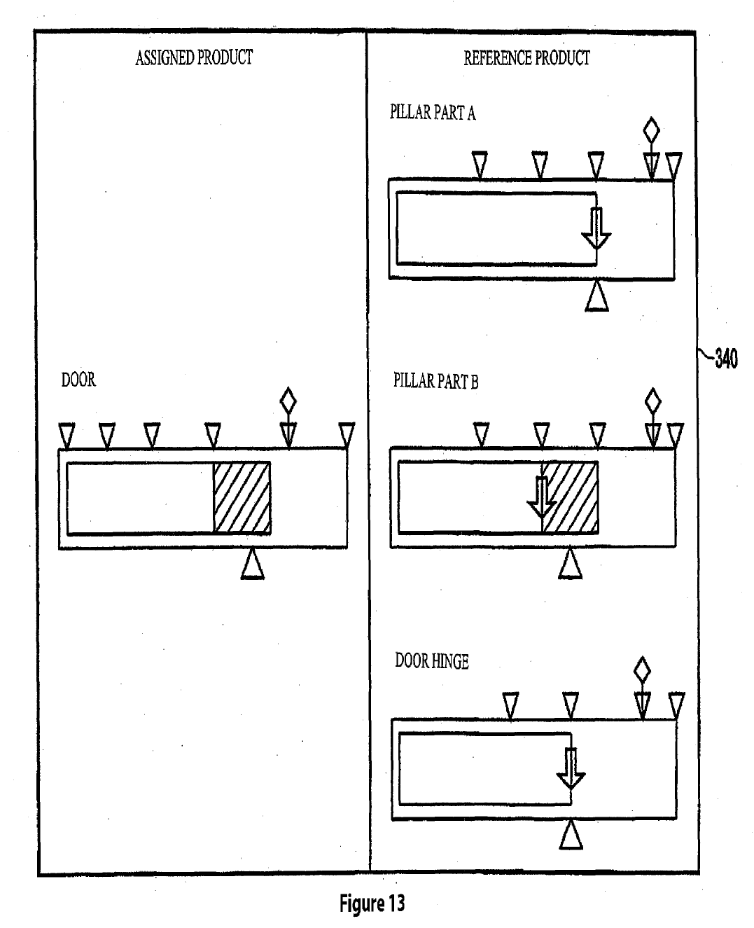

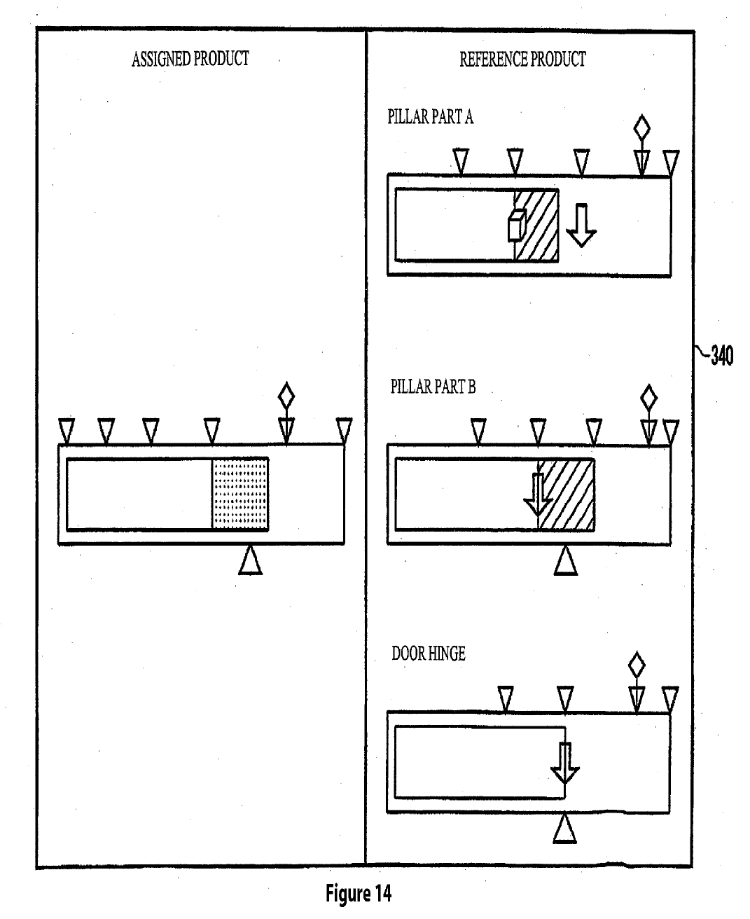

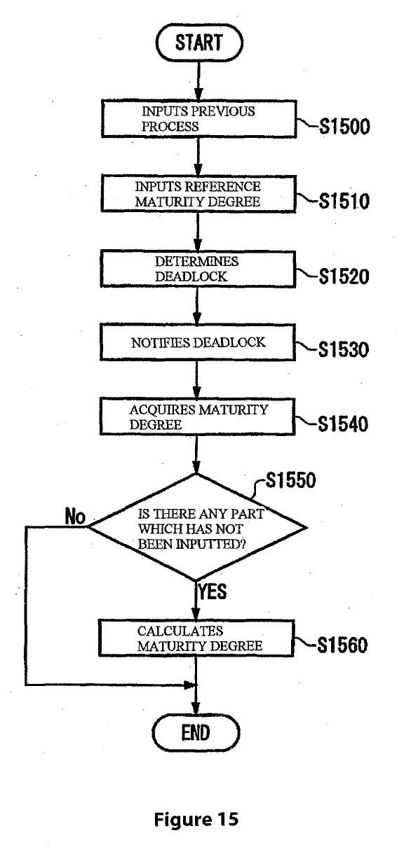

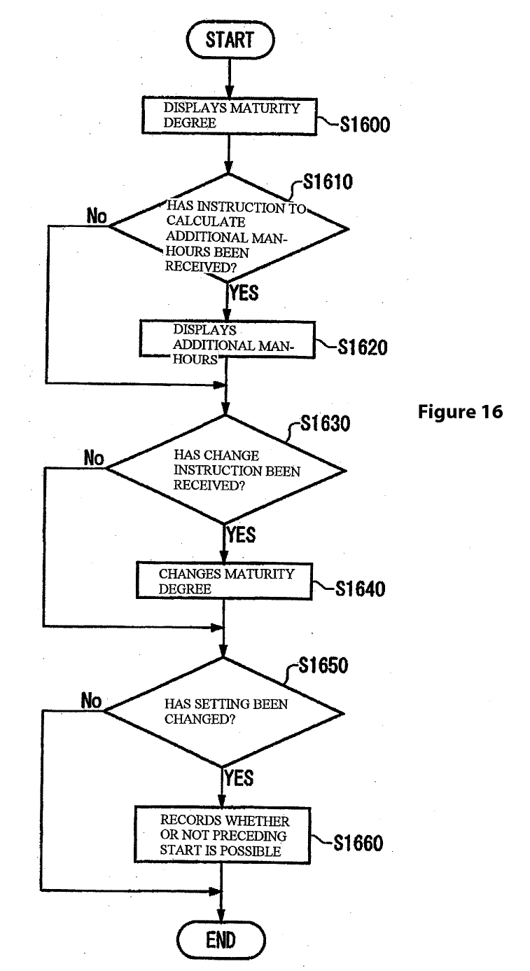

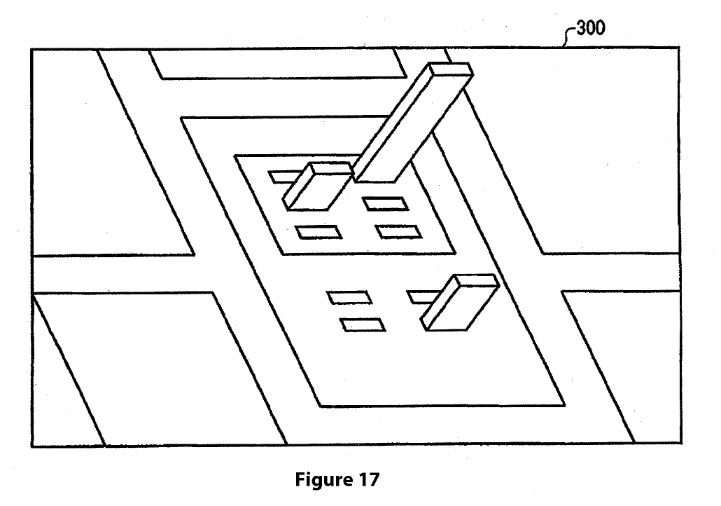

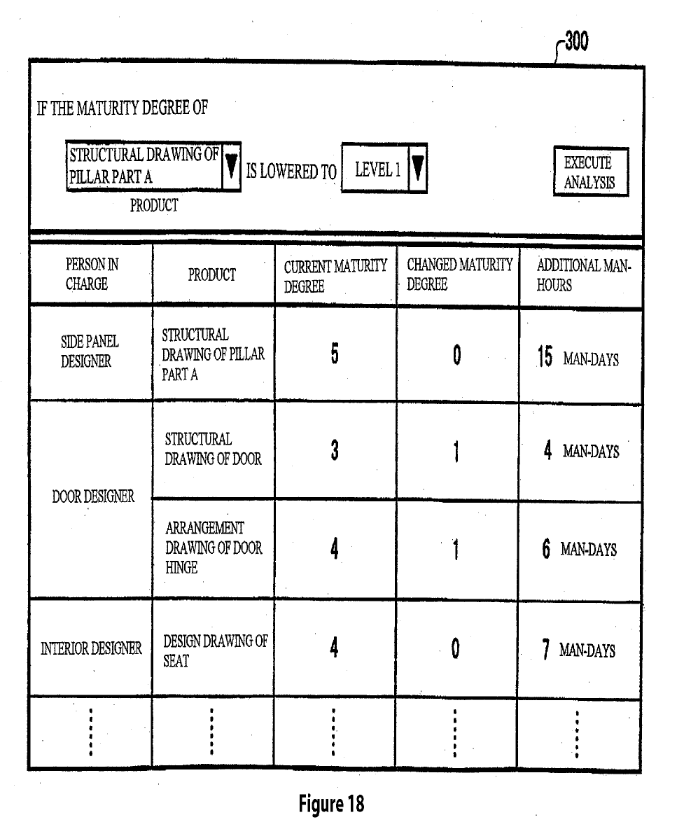

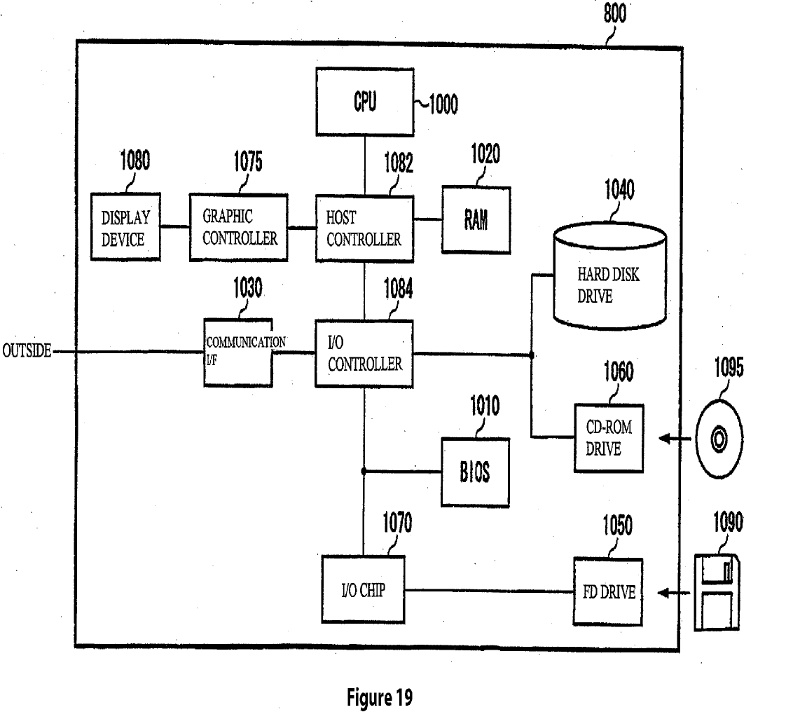

### DESCRIPTION OF SYMBOLS

30 manufacturing site network
40 work management system
50 processing section for person in charge
60 processing section for a manager
200 work process
205 product
210 work process
215 product
220 work process
225 product
230 work process
232 product
235 product
240 work process
300 manager terminal
310 manager terminal
320 person-in-charge terminal
330 person-in-charge terminal
340 person-in-charge terminal
350 person-in-charge terminal
360 person-in-charge terminal
400 process recording section
410 reference maturity degree recording section
420 maturity degree recording section
430 history recording section
500 input section
502 process input section
505 reference maturity degree input section
508 maturity degree acquisition section
510 notification section
520 deadlock detection section
530 process detection section
540 maturity detection section
550 weight recording section
560 maturity degree calculation section
570 maturity degree definition recording section
600 state display section
610 maturity degree changing section
620 additional man-hour calculation section
630 setting section
640 reference maturity degree update section
800 information processing apparatus

1. A work management method for managing the progress of work, comprising the steps of:
recording with a process recording section, in association with at least one of multiple work processes included in the work, previous processes which are other work processes providing a product for the work process;
recording with a reference maturity degree section, for each of the previous processes associated with one work process recorded in the process recording section, a reference maturity degree which is the maturity degree of the product of the previous process required to start the one work process;
acquiring a maturity degree acquisition section, for each of the previous processes recorded in the process recording section in association with the one work process, the maturity degree of the product of the previous process; and
notifying with a notification section that the one work process can be started on condition that, for every previous process recorded in the process recording section in association with the one work process, the maturity degree for the previous process is equal to or above the reference maturity degree for the previous process.

2. The work management method according to claim 1, further comprising the steps of:
detecting with a process detection section a preceding-start process, which is a work process started in a state that, at any previous process, the maturity degree of the product is below the reference maturity degree; and
detecting with a maturity detection section, on condition that the preceding-start process has been detected, the maturity degree of the product of any previous process of the preceding-start process has risen to the reference maturity degree or above; and
notifying, in response to the maturity degree of the product of the previous process of the preceding-start process having risen to the reference maturity degree or above, with the notification section notifies that the product is usable at the preceding-start process.

3. The work management method according to claim 2, further comprising the steps of:
setting with a setting section, in association with each work process, whether or not to permit start of the work in a state that, at any previous process of the work process, the maturity degree of the product is below the reference maturity degree; and
detecting with the process detection section the preceding-start process from among work processes the start of which has been permitted by the setting section.

4. The work management method according to claim 1, further comprising the steps of:
inputting with a reference maturity degree input section, in association with a specified work process, the reference maturity degree for each of the previous processes of the work process, on the basis of a user instruction; and
recording with the reference maturity degree recording section, the reference maturity degree inputted by the reference maturity degree input section in association with each of the previous processes of the work process.

5. The work management method according to claim 4, wherein:
recording with the reference maturity degree recording section, an initially set reference maturity degree which is a predetermined reference maturity degree, and, in response to a reference maturity degree having been inputted by the reference maturity degree input section, further recording the inputted reference maturity degree;
in the case where multiple reference maturity degrees are recorded in the reference maturity degree recording section for the same work process, comparing with the notification section, the reference maturity degree inputted by the reference maturity degree input section with the maturity degree; and
updating the work management system with a reference maturity degree update section, the initially set reference maturity degree with the reference maturity degree inputted by the reference maturity degree input section, on the basis of an instruction by the manager of the work.

6. The work management method according to claim 4, wherein in response to the maturity degree acquisition section having acquired, for the same work process, a maturity degree different from a maturity degree already acquired, the reference maturity degree input section requesting a user to specify the reference maturity degree of the work process required to start a work process for which the work process is a previous process, and inputting the reference maturity degree on the basis of specification by the user.

7. The work management method according to claim 4, wherein in response to the maturity degree acquisition section acquiring, for the same work process, a maturity degree higher than a maturity degree already acquired, requesting with the reference maturity degree input section, the user to specify the reference maturity degrees of the previous processes of the work process required to further raise the maturity degree of the product of the work process, and inputting the reference maturity degrees on the basis of specification by the user.

8. The work management method according to claim 4, further comprising the steps of:
inputting with a process input section, previous processes to provide a product for a specified work process and causing the process recording section to record the previous processes; and
detecting with a deadlock detection section, in response to the previous processes having been inputted by the process input section and a reference maturity degree having being inputted by the reference maturity degree input section, deadlock which means a relationship among multiple work processes each of which requires higher-maturity-degree products of the other work processes in order to generate a product with a higher maturity degree; and
on condition that deadlock has been detected by the deadlock detection section, notifying with the notification section, in association with information to the effect that the deadlock has been detected, that previous processes or the reference maturity degree are to be changed.

9. The work management method according to claim 1, further comprising displaying with a state display section, in association with each of the multiple work processes, the maturity degree of the product of the work process and information indicating whether or not the work of the work process has started in a state that, at any of the previous processes of the work process, the maturity degree of the product is below the reference maturity degree.

10. The work management method according to claim 1, wherein
in response to the fact that it is not possible to acquire the maturity degree of a product at any work process, acquiring with the maturity degree acquisition section, the maturity degree of the product of each of the previous processes of the work process for which the maturity degree of the product cannot be acquired;
calculating with a maturity degree calculation section, the maturity degree of the product of the work process for which the maturity degree cannot be acquired by the maturity degree acquisition section, on the basis of the maturity degree of the product of each of the previous processes of the work process; and
determining with the notification section, whether or not, at the previous processes of the one work process, the maturity degree of the product is equal to or above the reference maturity degree on the basis of the maturity degrees acquired by the maturity degree acquisition section or the maturity degree calculated by the maturity degree calculation section.

11. The work management method according to claim 10, further comprising the steps of:
recording with a weight recording section, in association with each of the previous processes of at least one work process, weight indicating the degree of contribution by the previous process to the product of the work process; and
calculating with the maturity degree calculation section, a value obtained by multiplying the maturity degree of the product of each of all the previous processes of the work process by weight corresponding to the previous process and summing up all the multiplied maturity degrees, as the maturity degree of the product of the work process for which the maturity degree cannot be acquired by the maturity degree acquisition section.

12. The work management method according to claim 1, further comprising the steps of:
recording with a maturity degree recording section, in association with each work process, the maturity degree acquired by the maturity degree acquisition section; and
changing with a maturity degree changing section which, as lowering the maturity degree of a product at any work process, lowers the maturity degrees of the products of other work processes using the product with the maturity degree.

13. The work management method according to claim 12, further comprising the steps of:
calculating with an additional man-hour calculation section, for a specified work process, additional man-hours which is the total man-hours required as a result of the maturity degrees being lowered by the maturity degree changing section in the case where the maturity degree of the product of the work process has been lowered; and
outputting with the maturity degree changing section the additional man-hours calculated by the additional man-hour calculation section to the user, and lowers the maturity degree of the product of the specified work process on condition that the user has agreed in response to the output of the additional man-hours.

14. The work management method according to claim 1, further comprising the steps of:
recording with a maturity degree definition recording section, in association with at least one of multiple work processes included in the work, definition of the maturity degree of the product of the work process; and
outputting with the maturity degree acquisition section, the definition recorded in the maturity degree definition recording section to the user and causing the user to specify the maturity degree of the product of the work process to acquire the maturity degree of the product.

15. The work management method according to claim 1, further comprising recording with a history recording section, on condition that the maturity degree acquisition section has acquired a maturity degree higher than a maturity degree already acquired at any work process, the number of processes required to raise the maturity degree of the product of the work process and the maturity degrees of the products of previous processes used to raise the maturity degree of the product.

16. (canceled)

17. A control method for a work management system for managing the progress of work;
the work management system comprising:
a process recording section which records, in association with at least one of multiple work processes included in the work, previous processes which are other work processes providing a product for the work process; and
a reference maturity degree recording section which records, for each of the previous processes associated with one work process recorded in the process recording section, a reference maturity degree which is the maturity degree of the product of the previous process required to start the one work process; and
the control method comprising the steps of:
acquiring, for each of the previous processes recorded in the process recording section in association with the one work process, the maturity degree of the product of the previous process; and
notifying that the one work process can be started on condition that, for every previous process recorded in the process recording section in association with the one work process, the maturity degree for the previous process is equal to or above the reference maturity degree for the previous process.

18. (canceled)
